(19) United States
(12) Patent Application Publication
(10) Pub. No.: US 2024/0025023 A1
(43) Pub. Date: Jan. 25, 2024

(54) Intelligent Control and Monitoring System for Bolt Fastening Load and Use Method Thereof

(71) Applicant: Chongqing University, Chongqing (CN)

(72) Inventors: Yang LUO, Chongqing (CN); Yang YANG, Chongqing (CN); Yuanxin LUO, Chongqing (CN); Jiahui YAN, Chongqing (CN); Qimin LI, Chongqing (CN)

(21) Appl. No.: 18/222,203

(22) Filed: Jul. 14, 2023

(30) Foreign Application Priority Data
Jul. 19, 2022 (CN) 202210849004.1

(51) Int. Cl. B25B 23/147; B25B 21/00

(52) U.S. Cl. CPC B25B 23/147; B25B 21/002

(57) ABSTRACT

The present disclosure discloses an intelligent control and monitoring system for bolt fastening load and a use method thereof. The system includes a bolt-washer combination; a fastening detection terminal configured to monitor tightness of a bolt, upload loosening risk information, and send onsite assembly information and onsite mounting information of the bolt; a smart electric wrench configured to pre-fasten the bolt based on the onsite assembly information of the bolt, and transmit the mounting information of the bolt; and a cloud platform configured to plan, take statistics, and store the mounting information of the bolt, confirm and monitor the mounting information of the bolt. According to the present disclosure, pre-fastening force to the bolt is more accurately controlled, a function of matching an IP address with a physical mounting address is provided, so that physical positioning can be quickly performed for a mounted fastening detection element.

### CROSS REFERENCE TO RELATED APPLICATION

This patent application claims the benefit and priority of Chinese Patent Application No. 202210849004.1, filed with the China National Intellectual Property Administration on Jul. 19, 2022, the disclosure of which is incorporated by reference herein in its entirety as part of the present application.

### TECHNICAL FIELD

The present disclosure relates to the technical field of intelligent tools, and in particular to an intelligent control and monitoring system for bolt fastening load and a use method thereof.

### BACKGROUND

When a bolt is in a connection service process, due to impact of load and environments, the bolt is prone to fatigue, creep, loosen, overload, and fracture. If a bolt at a key position is loose, a serious accident may occur, for example, an aircraft accident and bridge fracture. This results in inestimable loss. Therefore, scientific and accurate monitoring for a connection status of a bolted structure is of great importance to ensure safety of the structure and avoid a major safety accident. Therefore, monitoring for looseness of a bolt connection is very important to maintain an arrangement and reduce maintenance costs.

In a mounting phase of the bolt, equipment may be damaged due to high or low pre-fastening force of a wrench. One of key issues in the manufacturing industry focuses on accurately determining pre-fastening force for the bolt. When conventional equipment is mounted (for example, assembly of an automobile engine), fastening torque is usually controlled by a torque wrench, to achieve predetermined pre-fastening force for the bolt. However, actual pre-fastening force is closely related to roughness of a contact surface, a friction coefficient, lubrication, and other factors. Researches show that an error of pre-fastening force controlled by the torque wrench may be up to 40%. An excessive deviation of the pre-fastening force directly results in quality reduction of a product, increase of a defective percentage, and frequent accidents in a later period.

According to the present disclosure, based on an intelligent detection washer (Patent Number: CN215333898U WASHER FOR INTELLIGENTLY DETECTING LOOSENESS OF BOLT), in this solution, the bolt can be intelligently positioned, looseness between the bolt and a washer can be detected, and a nut can be accurately pre-fastened in a mounting process of the bolt.

However, at present, there is still a lack of a bolt mounting tool that can exchange information with the intelligent detection washer. Therefore, an operator does not quantify a mounting situation of the bolt and understand the fastening force for the bolt.

### SUMMARY

In view of this, the present disclosure provides an intelligent control and monitoring system for bolt fastening load and a use method thereof. A smart detection element directly monitors pre-fastening force to a bolt and controls an operation of a fastening wrench, so that the pre-fastening force to the bolt is more accurately controlled, and an error of fastening force caused by a torque method is avoided. The present disclosure has a function of matching an IP address with a physical mounting address, so that physical positioning can be quickly performed for a mounted fastening detection element, and an accurate positioning speed and accuracy of the physical positioning are improved.

The technical solutions are as follows:

An intelligent control and monitoring system for bolt fastening load includes a bolt-washer combination. The system further includes a fastening detection terminal mounted in the bolt-washer combination and configured to monitor tightness of a bolt, upload loosening risk information, and send onsite assembly information and onsite mounting information of the bolt;
a smart electric wrench configured to store a datasheet of N physical locations, pre-fasten the bolt based on the onsite assembly information of the bolt, and transmit the mounting information of the bolt; and
a cloud platform configured to plan, take statistics, and store the mounting information of the bolt, and confirm a mounting location of the bolt based on loosening risk information of any bolt.

In the present disclosure, the cloud platform plans all physical locations at which a smart bolt needs to be mounted, to enable the smart electric wrench to interact with the fastening detection terminal, and control a fastening force for mounting the bolt. In addition, the datasheet is used as a medium, when each bolt-washer combination is installed, the smart electric wrench inputs a physical location of each fastening detection terminal into the datasheet and matches IP information. In a subsequent service process of the bolt, the cloud platform monitors tightness between the bolt and the washer based on an information table. When the tightness exceeds a preset threshold, the cloud platform alarms, and therefore, a worker perform maintenance as soon as possible.

The fastening detection terminal may be embedded in a plurality of locations in the bolt-washer combination, for example, in a blot cap, a washer, or a nut.

The fastening detection terminal includes a primary contact and a secondary contact. A fastening detection terminal processor has a first pressure monitoring terminal, connected to the primary contact, and a second pressure monitoring terminal, connected to the secondary contact. The fastening detection terminal processor drives a communication module to send a signal.

In a mounting process, a bolt cap, a washer, or a nut in the combination of a bolt and a washer is squeezed, and pressure information is collected at the primary contact and the secondary contact of the fastening detection terminal. The fastening detection terminal sends the onsite assembly information to the smart electric wrench. The smart electric wrench adjusts a torque and a rotational speed based on the onsite assembly information. The onsite assembly information includes:
primary onsite assembly information, where if no pressure information is generated at the primary contact and the secondary contact, the smart electric wrench starts working at an initial torque and an initial rotational speed;
secondary onsite assembly information, where if the pressure information is sent from only the primary contact, the smart electric wrench starts working at an increased torque and decreased rotational speed; and
tertiary onsite assembly information, where if the pressure information is sent from the primary contact and the secondary contact, the smart electric wrench stops working.

The torque and the rotational speed may be specifically set based on different application scenarios, different use requirements, different types of bolts and washers.

Through rapid interaction of the onsite assembly information, pre-fastening force to the bolt can be directly monitored, and an operation of a fastening wrench can be controlled, so that the pre-fastening force to the bolt is more accurately controlled, and the bolt is intelligently fastened. This ensures consistency and reliability of mounting torque of all bolts.

The fastening detection terminal regularly detects tightness between the bolt and the washer. When the tightness exceeds a preset threshold, the fastening detection terminal sends the loosening risk information, and the loosening risk information includes information of the tightness and IP information of the fastening detection terminal.

When the bolt is in service for a long time, a disconnection signal of the secondary contact is preset to a first threshold, and a disconnection signal of the primary contact is preset to a second threshold value.

The fastening detection terminal regularly performs detection. A regular interval is set by the worker based on an actual situation, for example, the detection is separately performed every week or every half month, to ensure that a built-in power supply of the fastening detection terminal supports the detection for a long time.

The smart electric wrench matches information of a location of the fastening detection terminal, that is, matches information of a physical location corresponding to a mounting location of the fastening detection terminal with the IP information of the fastening detection terminal, to obtain the mounting information.

The mounting information includes IP information of a specific fastening detection terminal and information of a physical location matched with the specific fastening detection terminal. Subsequently, the cloud platform stores the mounting information.

The cloud platform completes physical positioning of a faulty bolt by obtaining the IP information of the fastening detection terminal in the loosening risk information and invoking mounting information corresponding to the cloud platform.

Due to targeted tracking and targeted alarming, work efficiency of maintenance personnel is improved.

The smart electric wrench includes a motor control circuit, a motor connected to the motor control circuit, and a power circuit configured to supply power to the motor control circuit. The motor control circuit is connected to a human-computer interaction circuit and a wireless communication circuit. The human-computer interaction circuit includes an input switch combination and a digital display circuit.

The input switch combination includes a match mode switch, a start switch, a first address selection switch, a second address selection switch, and an address confirmation switch. The input switch combination is connected to the motor control circuit through a match mode switch port, a start switch port, a first address selection switch port, a second address selection switch port, and an address confirmation switch port.

A display control terminal group of the motor control circuit is connected to a signal receiving terminal group of a driver module of the digital display circuit, and a driving terminal group of the driver module is connected to a display screen.

An operator selects and confirms a physical location displayed on the display screen by the address selection switch and the address confirmation switch, to realizing human-computer interaction.

A start control terminal of the motor control circuit is connected to a driving signal terminal of a relay, a first output terminal of the relay is connected to a first input terminal of the motor, and a second output terminal of the relay is selectively connected to a second input terminal or a third input terminal of the motor via a toggle switch.

The wireless communication circuit is connected to a data transmission terminal group of the motor control circuit through a first wireless data port and a second wireless data port.

The smart electric wrench further includes an SD card. The SD card is configured to store the datasheet, and the SD card is connected to an SD data terminal of the motor control circuit.

A use method of an intelligent control and monitoring system for bolt fastening load includes:
S1: taking statistics of mounting locations of all combinations of a bolt and a washer on a cloud platform, planning N physical locations, and generating a datasheet of the N physical locations, where each physical location has IP information of a fastening detection terminal in at least one bolt-washer combination, and fastening detection terminals at a same physical location share one piece of IP information;
S2: obtaining, by an SD card in a smart electric wrench, the datasheet from the cloud platform;
S3: completing, by the smart electric wrench, a process of mounting the bolt-washer combination on site, and filling information in the datasheet based on the physical location and the fastening detection terminal in the bolt-washer combination;
S4: sending, by the smart electric wrench, the datasheet filled with the information to the cloud platform through the SD card;
S5: regularly and remotely sending, by all fastening detection terminals, current status information to the cloud platform; and
S6: verifying, by the cloud platform, a current status of each fastening detection terminal one by one based on the datasheet, and displaying the current status of each fastening detection terminal.

The bolt is pre-fastened through an interconnection through the fastening detection terminal and the smart electric wrench. In addition, after the fastening detection terminal uploads loosening risk information, the fastening detection terminal can be accurately positioned.

In step S3, the process of mounting the bolt-washer combination on site includes:
searching the datasheet for a current physical location through human-machine interaction;
starting the smart electric wrench, where if no pressure information is detected at a primary contact and a secondary contact, the smart electric wrench starts working at an initial torque and an initial rotational speed;
if the smart electric wrench detects the pressure information sent from only the primary contact, the smart electric wrench starts working at an increased torque and decreased rotational speed; or
if the smart electric wrench detects the pressure information sent from the primary contact and the secondary contact, the smart electric wrench stops working;
sending, by the fastening detection terminal, the IP information to the smart electric wrench, to enable the smart electric wrench to match the IP information with the current physical location, and completing the filling of the information in the datasheet; and
stopping sending, by the fastening detection terminal, the information after a delay of T seconds.

In step S5, all fastening detection terminals send current statuses to a repeater based on a zigbee hopping solution, and the repeater forwards the current statuses to the cloud platform in a manner of a general packet radio service (GPRS) or code division multiple access (CDMA), to implement system initialization and long-term monitoring;
in a system initialization phase, in step S6, when the cloud platform verifies that there is a fastening detection terminal without the current status information, the cloud platform sends a terminal missing alarm message; and
in a long-term monitoring phase, when a specific secondary contact is disconnected, current status information sent by a fastening detection terminal at the secondary contact is a fault alarm message, the fault alarm message includes the IP information of the fastening detection terminal, and the secondary contact is closed again until the bolt-washer combination is refastened.

In the system initialization phase, after the cloud platform sends the terminal missing alarm message, the bolt-washer combination of the fastening detection terminal is reconstructed, that is, a high-power washer is added. A high-power battery and a high-power communication module are disposed in the high-power washer. The high-power battery supplies power to the high-power communication module. A signal input terminal group of the high-power communication module is connected to a signal output terminal group in the washer.

In an initial phase of a system design, when the system is practically used, an actual situation does not meet an actual need. Once network-wide monitoring is not supported under actual conditions on site, there is a systematic risk. Therefore, an emergency plan is designed to quickly resolve a problem without additional construction and an auxiliary condition and with lowest costs. This technical solution is quickly integrated into an original design, does not result any technical conflict to the original system, and is appropriate to onsite treatment, so that operability is strong.

An energy-saving circuit is also disposed in the high-power washer. The energy-saving circuit includes an amplifier. A power terminal of the amplifier is connected to a transmit antenna driving terminal of the fastening detection terminal, an input terminal of the amplifier is connected to a control signal output terminal of the fastening detection terminal, and an output terminal of the amplifier is connected to a base of a switching triode. A collector and an emitter of the switching triode are serially connected in a power supply circuit that is configured to control the high-power communication module.

Energy consumption minimization in the high-power washer can be realized through awakening effect of a smart washer. This solution is simply upgraded, and skill requirements for a constructor are reduced.

The output terminal of the amplifier is connected to the base of the switching triode through a unidirectional diode, and an energy storage capacitor is connected between the base of the triode and ground. A digital pulse signal at the output terminal of the amplifier does not continuously drive the switching triode to work. However, the unidirectional diode and the energy storage capacitor can ensure that the base of the switching triode continuously obtains a high level for a long time, to maintain a normal operation of a 5G module.

Compared with a conventional technology, the present disclosure has the following beneficial effect: A smart detection element directly monitors pre-fastening force to a bolt and controls an operation of a fastening wrench, so that the pre-fastening force to the bolt is more accurately controlled, and an error of fastening force caused by a torque method is avoided. After a conventional force measurement element is mounted, a physical location of each element needs to be separately calibrated, which is time-consuming and laborious. The developed system has a function of matching an IP address with a physical mounting address, so that physical positioning can be quickly performed for a mounted fastening detection element, and an accurate positioning speed and accuracy of the physical positioning are improved.

### BRIEF DESCRIPTION OF THE DRAWINGS

FIG. 1 is a schematic diagram of a relationship of a positioning system according to the present disclosure;

FIG. 2 is a schematic diagram of a motor control circuit of a smart electric wrench according to the present disclosure;

FIG. 3 is a schematic diagram of a circuit of a relay of a smart electric wrench according to the present disclosure;

FIG. 4 is a schematic diagram of a wireless communication circuit of a smart electric wrench according to the present disclosure;

FIG. 5 is a schematic diagram of a digital display circuit of a smart electric wrench according to the present disclosure;

FIG. 6 is a schematic diagram of a circuit of a switch combination of a smart electric wrench according to the present disclosure;

FIG. 7 is a schematic diagram of a structure of a fastening detection terminal according to present disclosure;

FIG. 8 is a schematic diagram of working of a smart electric wrench according to the present disclosure;

FIG. 9 is a schematic diagram A of a mounting process of a bolt;

FIG. 10 is a schematic diagram B of a mounting process of a bolt; and

FIG. 11 is a schematic diagram of drawing of a circuit of a high-power washer.

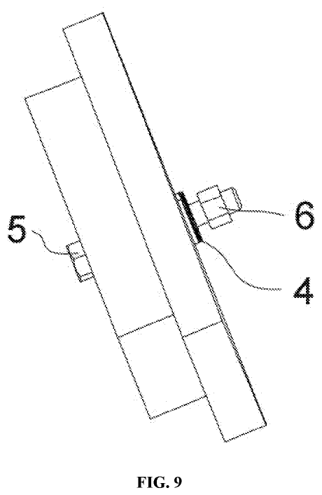

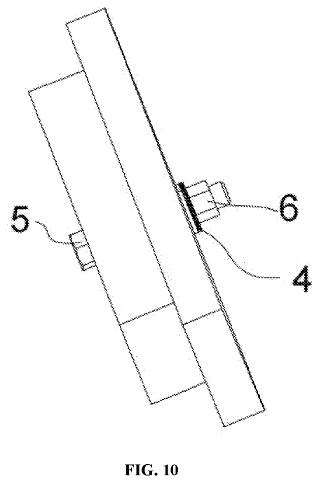

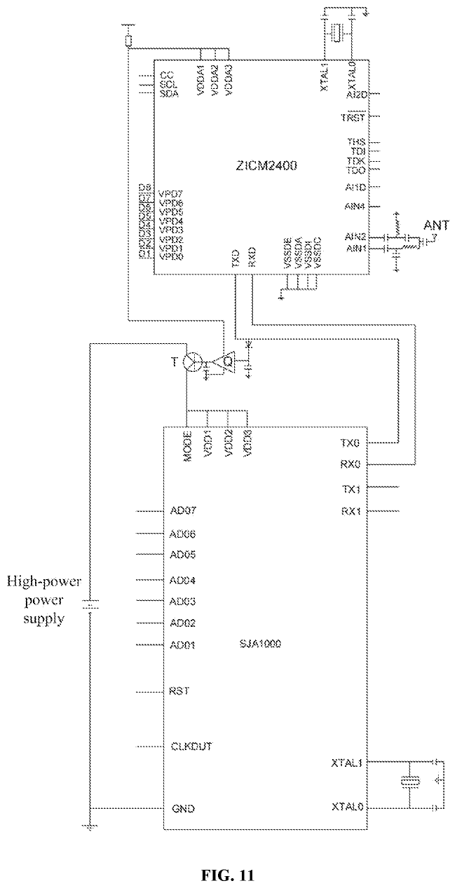

In FIG. 8 to FIG. 10, 1—primary contact, 2—secondary contact, 3—smart electric wrench, 4—fastening detection terminal, 5—bolt, and 6—nut.

### DETAILED DESCRIPTION OF THE EMBODIMENTS

The following further describes the present disclosure with reference to embodiments and the accompanying drawings.

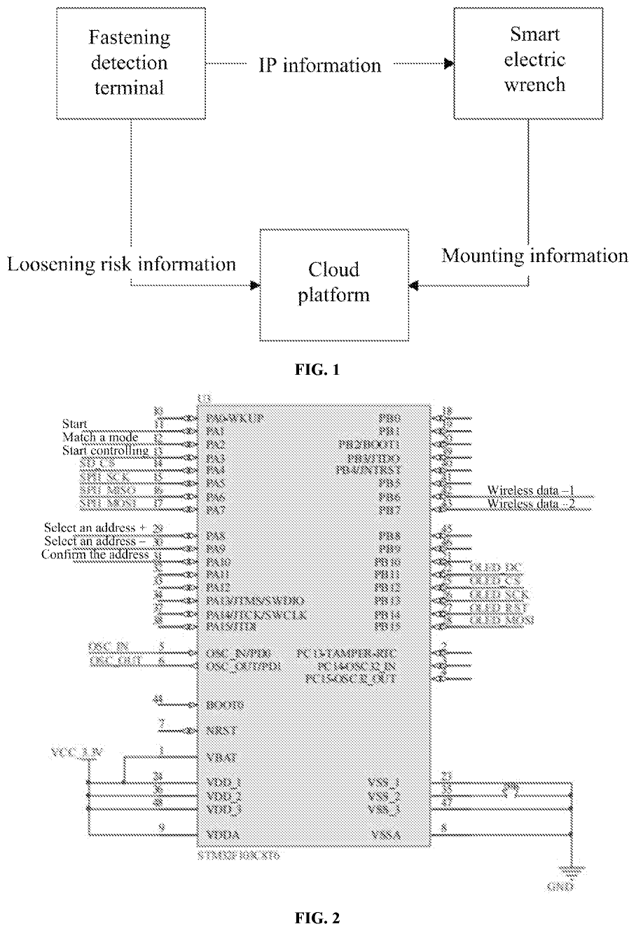

As shown in FIG. 1, an intelligent control and monitoring system for bolt fastening load includes a bolt-washer combination, a fastening detection terminal, mounted in the bolt-washer combination and configured to monitor tightness of a bolt, upload loosening risk information, and send onsite assembly information and onsite mounting information of the bolt;

a smart electric wrench configured to store a datasheet of N physical locations, pre-fasten the bolt based on the onsite assembly information of the bolt, and transmit the mounting information of the bolt; and

a cloud platform configured to plan, take statistics, and store the mounting information of the bolt, and confirm a mounting location of the bolt based on loosening risk information of any bolt.

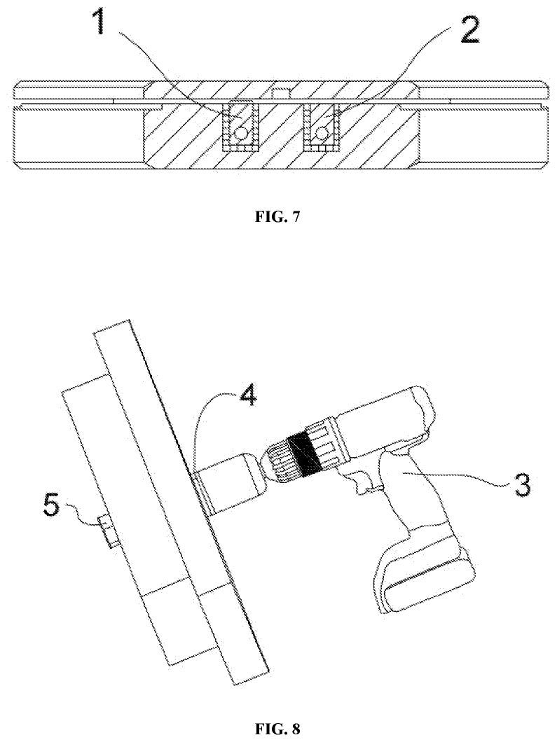

As shown in FIG. 7 to FIG. 10, a fastening detection terminal includes a primary contact and a second contact. In a mounting process, a bolt cap, a washer, or a nut in the combination of a bolt and a washer is squeezed, and pressure information is collected at the primary contact and the secondary contact of the fastening detection terminal. The fastening detection terminal sends the onsite assembly information to the smart electric wrench. The smart electric wrench adjusts a torque and a rotational speed based on the onsite assembly information. The onsite assembly information includes:

primary onsite assembly information, where if no pressure information is generated at the primary contact and the secondary contact, the smart electric wrench starts working at an initial torque and an initial rotational speed;

secondary onsite assembly information, where if the pressure information is sent from only the primary contact, the smart electric wrench starts working at an increased torque and decreased rotational speed; and

tertiary onsite assembly information, where if the pressure information is sent from the primary contact and the secondary contact, the smart electric wrench stops working.

The fastening detection terminal regularly detects tightness between the bolt and the washer. When the tightness exceeds a preset threshold, the fastening detection terminal sends the loosening risk information, and the loosening risk information includes information of the tightness and IP information of the fastening detection terminal.

The smart electric wrench matches information of a location of the fastening detection terminal, that is, matches information of a physical location corresponding to a mounting location of the fastening detection terminal with the IP information of the fastening detection terminal, to obtain the mounting information.

The cloud platform completes physical positioning of a faulty bolt by obtaining the IP information of the fastening detection terminal in the loosening risk information and invoking mounting information corresponding to the cloud platform.

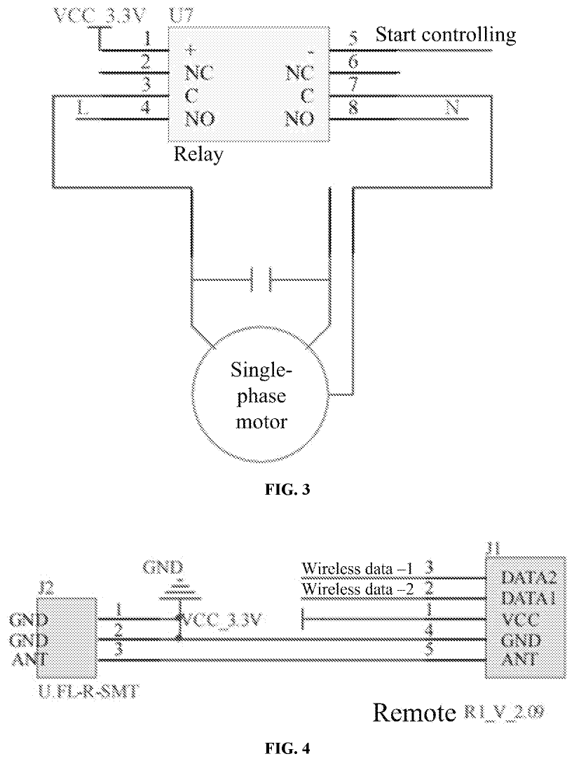

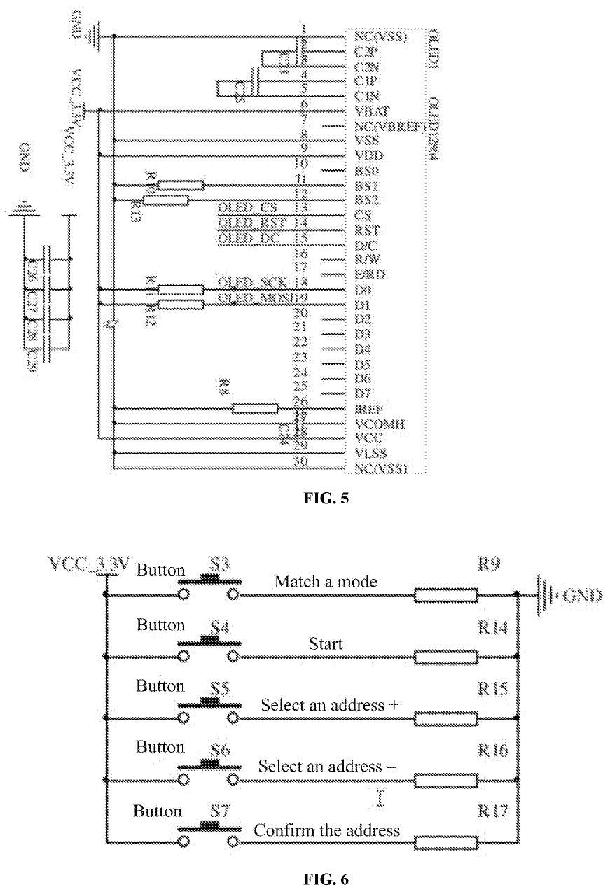

As shown in FIG. 2 to FIG. 6, the smart electric wrench includes a motor control circuit, a motor connected to the motor control circuit, and a power circuit configured to supply power to the motor control circuit. The motor control circuit is connected to a human-computer interaction circuit and a wireless communication circuit. The human-computer interaction circuit includes an input switch combination and a digital display circuit.

The input switch combination includes a match mode switch, a start switch, a first address selection switch, a second address selection switch, and an address confirmation switch. The input switch combination is connected to the motor control circuit through a match mode switch port, a start switch port, a first address selection switch port, a second address selection switch port, and an address confirmation switch port.

A display control terminal group of the motor control circuit is connected to a signal receiving terminal group of a driver module of the digital display circuit, and a driving terminal group of the driver module is connected to a display screen.

A start control terminal of the motor control circuit is connected to a driving signal terminal of a relay, a first output terminal of the relay is connected to a first input terminal of the motor, and a second output terminal of the relay is selectively connected to a second input terminal or a third input terminal of the motor via a toggle switch.

The wireless communication circuit is connected to a data transmission terminal group of the motor control circuit through a first wireless data port and a second wireless data port.

The smart electric wrench further includes an SD card. The SD card is configured to store the datasheet, and the SD card is connected to an SD data terminal of the motor control circuit.

A use method of an intelligent control and monitoring system for bolt fastening load includes:
S1: taking statistics of mounting locations of all combinations of a bolt and a washer on a cloud platform, planning N physical locations, and generating a datasheet of the N physical locations, where each physical location has IP information of a fastening detection terminal in at least one bolt-washer combination, and fastening detection terminals at a same physical location share one piece of IP information;
S2: obtaining, by an SD card in a smart electric wrench, the datasheet from the cloud platform;
S3: completing, by the smart electric wrench, a process of mounting the bolt-washer combination on site, and filling information in the datasheet based on the physical location and the fastening detection terminal in the bolt-washer combination;
S4: sending, by the smart electric wrench, the datasheet filled with the information to the cloud platform through the SD card;
S5: regularly and remotely sending, by all fastening detection terminals, current status information to the cloud platform; and
S6: verifying, by the cloud platform, a current status of each fastening detection terminal one by one based on the datasheet, and displaying the current status of each fastening detection terminal.

In step S3, the process of mounting the bolt-washer combination on site includes:
searching the datasheet for a current physical location through human-machine interaction;
starting the smart electric wrench, where if no pressure information is detected at a primary contact and a secondary contact, the smart electric wrench starts working at an initial torque and an initial rotational speed;
if the smart electric wrench detects the pressure information sent from only the primary contact, the smart electric wrench starts working at an increased torque and decreased rotational speed; or
if the smart electric wrench detects the pressure information sent from the primary contact and the secondary contact, the smart electric wrench stops working;
sending, by the fastening detection terminal, the IP information to the smart electric wrench, to enable the smart electric wrench to match the IP information with the current physical location, and completing the filling of the information in the datasheet; and
stopping sending, by the fastening detection terminal, the information after a delay of T seconds.

In step S5, all fastening detection terminals send current statuses to a repeater based on a zigbee hopping solution, and the repeater forwards the current statuses to the cloud platform in a manner of a general packet radio service (GPRS) or code division multiple access (CDMA), to implement system initialization and long-term monitoring;
in a system initialization phase, in step S6, when the cloud platform verifies that there is a fastening detection terminal without the current status information, the cloud platform sends a terminal missing alarm message; and
in a long-term monitoring phase, when a specific secondary contact is disconnected, current status information sent by a fastening detection terminal at the secondary contact is a fault alarm message, the fault alarm message includes the IP information of the fastening detection terminal, and the secondary contact is closed again until the bolt-washer combination is refastened.

In the system initialization phase, after the cloud platform sends the terminal missing alarm message, the bolt-washer combination of the fastening detection terminal is reconstructed, as shown in FIG. 11, a high-power washer is added. A high-power battery and a high-power communication module are disposed in the high-power washer. The high-power battery supplies power to the high-power communication module. A signal input terminal group of the high-power communication module is connected to a signal output terminal group in the washer.

An energy-saving circuit is also disposed in the high-power washer. The energy-saving circuit includes an amplifier Q. A power terminal of the amplifier Q obtains drive power, is connected to a power terminal of the fastening detection terminal, and is connected to a transmit antenna driving terminal ANT of the fastening detection terminal.

An input terminal of the amplifier Q is connected to a control signal output terminal of the fastening detection terminal, and an output terminal of the amplifier Q is connected to a base of a switching triode T. A collector and an emitter of the switching triode T are serially connected in a power supply circuit that is configured to control the high-power communication module.

The output terminal of the amplifier is connected to the base of the switching triode through a unidirectional diode, and an energy storage capacitor is connected between the base of the triode and ground.

When the fastening detection terminal starts to work, because the fastening detection terminal has a regular wake-up function, the energy-saving circuit in the high-power washer is directly started based on working power and a working signal of the fastening detection terminal. After the energy-saving circuit is turned on, the high-power power supply supplies power to the high-power communication module. The high-power communication module can be a 5G module, and a data input terminal group of the high-power communication module can directly work after obtaining output data of the fastening detection terminal. A structure of the whole circuit is compact.

This solution can be simply upgraded, and can be implemented by connecting only 2 to 3 wires between washers. When an output wire of a unidirectional signal line and the driving power of the amplifier are collinear, only two wires are needed.

Finally, it should be noted that the above description is only a preferred embodiment of the present disclosure. Under the enlightenment of the present disclosure, those of ordinary skill in the art can make a variety of similar representations without departing from the purpose of the present disclosure and the claims, and such transformations all fall within the protection scope of the present disclosure.

What is claimed is:

1. An intelligent control and monitoring system for bolt fastening load, comprising a bolt-washer combination, wherein the system further comprises:
a fastening detection terminal mounted in the bolt-washer combination and configured to monitor tightness of a bolt, upload loosening risk information, and send onsite assembly information and onsite mounting information of the bolt;
a smart electric wrench configured to store a datasheet of N physical locations, pre-fasten the bolt based on the onsite assembly information of the bolt, and transmit the mounting information of the bolt; and
a cloud platform configured to plan, take statistics, and store the mounting information of the bolt, and confirm a mounting location of the bolt based on loosening risk information of any bolt.

2. The intelligent control and monitoring system for bolt fastening load according to claim 1, wherein the fastening detection terminal comprises a primary contact and a secondary contact, in a mounting process, a bolt cap, a washer, or a nut in the combination of a bolt and a washer is squeezed, pressure information is collected at the primary contact and the secondary contact of the fastening detection terminal, and the fastening detection terminal sends the onsite assembly information to the smart electric wrench, the smart electric wrench adjusts a torque and a rotational speed based on the onsite assembly information, and the onsite assembly information comprises:
primary onsite assembly information, wherein if no pressure information is generated at the primary contact and the secondary contact, the smart electric wrench starts working at an initial torque and an initial rotational speed;
secondary onsite assembly information, wherein if the pressure information is sent from only the primary contact, the smart electric wrench starts working at an increased torque and decreased rotational speed; and
tertiary onsite assembly information, wherein if the pressure information is sent from the primary contact and the secondary contact, the smart electric wrench stops working.

3. The intelligent control and monitoring system for bolt fastening load according to claim 1, wherein the fastening detection terminal regularly detects tightness between the bolt and the washer, and when the tightness exceeds a preset threshold, the fastening detection terminal sends the loosening risk information, and the loosening risk information comprises information of the tightness and IP information of the fastening detection terminal.

4. The intelligent control and monitoring system for bolt fastening load according to claim 3, wherein the smart electric wrench matches information of a location of the fastening detection terminal, that is, matches information of a physical location corresponding to a mounting location of the fastening detection terminal with the IP information of the fastening detection terminal, to obtain the mounting information.

5. The intelligent control and monitoring system for bolt fastening load according to claim 3, wherein the cloud platform completes physical positioning of a faulty bolt by obtaining the IP information of the fastening detection terminal in the loosening risk information and invoking mounting information corresponding to the cloud platform.

6. The intelligent control and monitoring system for bolt fastening load according to claim 1, wherein the smart electric wrench comprises a motor control circuit, a motor connected to the motor control circuit, and a power circuit configured to supply power to the motor control circuit, the motor control circuit is connected to a human-computer interaction circuit and a wireless communication circuit, and the human-computer interaction circuit comprises an input switch combination and a digital display circuit;
the input switch combination comprises a match mode switch, a start switch, a first address selection switch, a second address selection switch, and an address confirmation switch, the input switch combination is connected to the motor control circuit through a match mode switch port, a start switch port, a first address selection switch port, a second address selection switch port, and an address confirmation switch port;
a display control terminal group of the motor control circuit is connected to a signal receiving terminal group of a driver module of the digital display circuit, and a driving terminal group of the driver module is connected to a display screen;
a start control terminal of the motor control circuit is connected to a driving signal terminal of a relay, a first output terminal of the relay is connected to a first input terminal of the motor, and a second output terminal of the relay is selectively connected to a second input terminal or a third input terminal of the motor via a toggle switch;
the wireless communication circuit is connected to a data transmission terminal group of the motor control circuit through a first wireless data port and a second wireless data port; and
the smart electric wrench further comprises an SD card, the SD card is configured to store the datasheet, and the SD card is connected to an SD data terminal of the motor control circuit.

7. A use method of the intelligent control and monitoring system for bolt fastening load according to claim 1, comprising the following steps:
S1: taking statistics of mounting locations of all combinations of a bolt and a washer on the cloud platform, planning the N physical locations, and generating the datasheet of N physical locations, wherein each physical location has IP information of a fastening detection terminal in at least one bolt-washer combination, and fastening detection terminals at a same physical location share one piece of IP information;
S2: obtaining, by the SD card in the smart electric wrench, the datasheet from the cloud platform;
S3: completing, by the smart electric wrench, a process of mounting the bolt-washer combination on site, and filling information in the datasheet based on the physical location and the fastening detection terminal in the bolt-washer combination;
S4: sending, by the smart electric wrench, the datasheet filled with the information to the cloud platform through the SD card;
S5: regularly and remotely sending, by all fastening detection terminals, current status information to the cloud platform; and
S6: verifying, by the cloud platform, a current status of each fastening detection terminal one by one based on the datasheet, and displaying the current status of each fastening detection terminal.

8. The use method according to claim 7, wherein the fastening detection terminal comprises a primary contact and a secondary contact, in a mounting process, a bolt cap, a washer, or a nut in the combination of a bolt and a washer is squeezed, pressure information is collected at the primary contact and the secondary contact of the fastening detection terminal, and the fastening detection terminal sends the onsite assembly information to the smart electric wrench, the smart electric wrench adjusts a torque and a rotational speed based on the onsite assembly information, and the onsite assembly information comprises:
primary onsite assembly information, wherein if no pressure information is generated at the primary contact and the secondary contact, the smart electric wrench starts working at an initial torque and an initial rotational speed;
secondary onsite assembly information, wherein if the pressure information is sent from only the primary contact, the smart electric wrench starts working at an increased torque and decreased rotational speed; and
tertiary onsite assembly information, wherein if the pressure information is sent from the primary contact and the secondary contact, the smart electric wrench stops working.

9. The use method according to claim 7, wherein the fastening detection terminal regularly detects tightness between the bolt and the washer, and when the tightness exceeds a preset threshold, the fastening detection terminal sends the loosening risk information, and the loosening risk information comprises information of the tightness and IP information of the fastening detection terminal.

10. The use method according to claim 9, wherein the smart electric wrench matches information of a location of the fastening detection terminal, that is, matches information of a physical location corresponding to a mounting location of the fastening detection terminal with the IP information of the fastening detection terminal, to obtain the mounting information.

11. The use method according to claim 9, wherein the cloud platform completes physical positioning of a faulty bolt by obtaining the IP information of the fastening detection terminal in the loosening risk information and invoking mounting information corresponding to the cloud platform.

12. The use method according to claim 7, wherein the smart electric wrench comprises a motor control circuit, a motor connected to the motor control circuit, and a power circuit configured to supply power to the motor control circuit, the motor control circuit is connected to a human-computer interaction circuit and a wireless communication circuit, and the human-computer interaction circuit comprises an input switch combination and a digital display circuit;
the input switch combination comprises a match mode switch, a start switch, a first address selection switch, a second address selection switch, and an address confirmation switch, the input switch combination is connected to the motor control circuit through a match mode switch port, a start switch port, a first address selection switch port, a second address selection switch port, and an address confirmation switch port;
a display control terminal group of the motor control circuit is connected to a signal receiving terminal group of a driver module of the digital display circuit, and a driving terminal group of the driver module is connected to a display screen;
a start control terminal of the motor control circuit is connected to a driving signal terminal of a relay, a first output terminal of the relay is connected to a first input terminal of the motor, and a second output terminal of the relay is selectively connected to a second input terminal or a third input terminal of the motor via a toggle switch;
the wireless communication circuit is connected to a data transmission terminal group of the motor control circuit through a first wireless data port and a second wireless data port; and
the smart electric wrench further comprises an SD card, the SD card is configured to store the datasheet, and the SD card is connected to an SD data terminal of the motor control circuit.

13. The use method according to claim 7, when in step S3, the process of mounting the bolt-washer combination on site comprises:
searching the datasheet for a current physical location through human-machine interaction;
starting the smart electric wrench, wherein if no pressure information is detected at the primary contact and the secondary contact, the smart electric wrench starts working at the initial torque and the initial rotational speed;
if the smart electric wrench detects the pressure information sent from only the primary contact, the smart electric wrench starts working at an increased torque and decreased rotational speed; or
if the smart electric wrench detects the pressure information sent from the primary contact and the secondary contact, the smart electric wrench stops working;
sending, by the fastening detection terminal, the IP information to the smart electric wrench, to enable the smart electric wrench to match the IP information with the current physical location, and completing the filling of the information in the datasheet; and
stopping sending, by the fastening detection terminal, the information after a delay of T seconds.

14. The use method according to claim 8, when in step S3, the process of mounting the bolt-washer combination on site comprises:
searching the datasheet for a current physical location through human-machine interaction;
starting the smart electric wrench, wherein if no pressure information is detected at the primary contact and the secondary contact, the smart electric wrench starts working at the initial torque and the initial rotational speed;
if the smart electric wrench detects the pressure information sent from only the primary contact, the smart electric wrench starts working at an increased torque and decreased rotational speed; or
if the smart electric wrench detects the pressure information sent from the primary contact and the secondary contact, the smart electric wrench stops working;
sending, by the fastening detection terminal, the IP information to the smart electric wrench, to enable the smart electric wrench to match the IP information with the current physical location, and completing the filling of the information in the datasheet; and
stopping sending, by the fastening detection terminal, the information after a delay of T seconds.

15. The use method according to claim 9, when in step S3, the process of mounting the bolt-washer combination on site comprises:
searching the datasheet for a current physical location through human-machine interaction;
starting the smart electric wrench, wherein if no pressure information is detected at the primary contact and the secondary contact, the smart electric wrench starts working at the initial torque and the initial rotational speed;
if the smart electric wrench detects the pressure information sent from only the primary contact, the smart electric wrench starts working at an increased torque and decreased rotational speed; or
if the smart electric wrench detects the pressure information sent from the primary contact and the secondary contact, the smart electric wrench stops working;
sending, by the fastening detection terminal, the IP information to the smart electric wrench, to enable the smart electric wrench to match the IP information with the current physical location, and completing the filling of the information in the datasheet; and
stopping sending, by the fastening detection terminal, the information after a delay of T seconds.

16. The use method according to claim 10, when in step S3, the process of mounting the bolt-washer combination on site comprises:
searching the datasheet for a current physical location through human-machine interaction;
starting the smart electric wrench, wherein if no pressure information is detected at the primary contact and the secondary contact, the smart electric wrench starts working at the initial torque and the initial rotational speed;
if the smart electric wrench detects the pressure information sent from only the primary contact, the smart electric wrench starts working at an increased torque and decreased rotational speed; or
if the smart electric wrench detects the pressure information sent from the primary contact and the secondary contact, the smart electric wrench stops working;
sending, by the fastening detection terminal, the IP information to the smart electric wrench, to enable the smart electric wrench to match the IP information with the current physical location, and completing the filling of the information in the datasheet; and
stopping sending, by the fastening detection terminal, the information after a delay of T seconds.

17. The use method according to claim 11, when in step S3, the process of mounting the bolt-washer combination on site comprises:
searching the datasheet for a current physical location through human-machine interaction;
starting the smart electric wrench, wherein if no pressure information is detected at the primary contact and the secondary contact, the smart electric wrench starts working at the initial torque and the initial rotational speed;
if the smart electric wrench detects the pressure information sent from only the primary contact, the smart electric wrench starts working at an increased torque and decreased rotational speed; or
if the smart electric wrench detects the pressure information sent from the primary contact and the secondary contact, the smart electric wrench stops working;
sending, by the fastening detection terminal, the IP information to the smart electric wrench, to enable the smart electric wrench to match the IP information with the current physical location, and completing the filling of the information in the datasheet; and
stopping sending, by the fastening detection terminal, the information after a delay of T seconds.

18. The use method according to claim 12, when in step S3, the process of mounting the bolt-washer combination on site comprises:
searching the datasheet for a current physical location through human-machine interaction;
starting the smart electric wrench, wherein if no pressure information is detected at the primary contact and the secondary contact, the smart electric wrench starts working at the initial torque and the initial rotational speed;
if the smart electric wrench detects the pressure information sent from only the primary contact, the smart electric wrench starts working at an increased torque and decreased rotational speed; or
if the smart electric wrench detects the pressure information sent from the primary contact and the secondary contact, the smart electric wrench stops working;
sending, by the fastening detection terminal, the IP information to the smart electric wrench, to enable the smart electric wrench to match the IP information with the current physical location, and completing the filling of the information in the datasheet; and
stopping sending, by the fastening detection terminal, the information after a delay of T seconds.

19. The use method according to claim 7, wherein in step S5, all fastening detection terminals send current statuses to a repeater based on a zigbee hopping solution, and the repeater forwards the current statuses to the cloud platform in a manner of a general packet radio service (GPRS) or code division multiple access (CDMA), to implement system initialization and long-term monitoring;
in a system initialization phase, in step S6, when the cloud platform verifies that there is a fastening detection terminal without the current status information, the cloud platform sends a terminal missing alarm message; and
in a long-term monitoring phase, when a specific secondary contact is disconnected, current status information sent by a fastening detection terminal at the secondary contact is a fault alarm message, the fault alarm message comprises the IP information of the fastening detection terminal, and the secondary contact is closed again until the bolt-washer combination is refastened.

20. The use method according to claim 9, wherein in the system initialization phase, after the cloud platform sends the terminal missing alarm message, the bolt-washer combination of the fastening detection terminal is reconstructed, that is, a high-power washer is added, a high-power battery and a high-power communication module are disposed in the high-power washer, the high-power battery supplies power to the high-power communication module, and a signal input terminal group of the high-power communication module is connected to a signal output terminal group in the washer;
an energy-saving circuit is also disposed in the high-power washer, the energy-saving circuit comprises an amplifier, a power terminal of the amplifier is connected to a transmit antenna driving terminal of the fastening detection terminal, an input terminal of the amplifier is connected to a control signal output terminal of the fastening detection terminal, an output terminal of the amplifier is connected to a base of a switching triode, a collector and an emitter of the switching triode are serially connected in a power supply circuit that is configured to control the high-power communication module; and
the output terminal of the amplifier is connected to the base of the switching triode through a unidirectional diode, and an energy storage capacitor is connected between the base of the triode and ground.
